(19) United States
(12) Patent Application Publication
(10) Pub. No.: US 2026/0260225 A1
(43) Pub. Date: Sep. 3, 2026

(54) POS SYSTEM, DELIVERY ARRANGEMENT SYSTEM, METHOD, AND RECORDING MEDIUM

(71) Applicant: NEC Corporation, Tokyo (JP)

(72) Inventors: Hideo URAI, Tokyo (JP); Kanako HATAYAMA, Tokyo (JP)

(73) Assignee: NEC Corporation, Tokyo (JP)

(21) Appl. No.: 19/459,314

(22) Filed: Jan. 26, 2026

(30) Foreign Application Priority Data
Mar. 3, 2025 (JP) 2025-032586

(51) Int. Cl. G06Q 20/20; G06Q 10/083

(52) U.S. Cl. CPC G06Q 20/202; G06Q 10/083

(57) ABSTRACT

A POS system according to the present disclosure includes at least one memory storing instructions; and at least one processor configured to execute the instructions to: register a product for which an operation of reading product information for identifying the product at a store has been performed, receive selection to deliver the product; acquire customer information for identifying a customer who makes a payment and information about a delivery destination of the product, perform in-store accounting processing for the product, and output a request for delivery of the product from electronic commerce inventory based on the customer information and the information about the delivery destination.

### CROSS REFERENCE RELATED TO AN APPLICATION

This application is based upon and claims the benefit of priority from Japanese patent application No. 2025-032586, filed on March 3, 2025, the disclosure of which is incorporated herein in its entirety by reference.

### TECHNICAL FIELD

The present disclosure relates to a delivery arrangement system and the like.

### BACKGROUND ART

In the modern retail industry, an Online Merges with Offline (OMO) strategy that integrates online and offline purchasing experiences is increasing in importance. A customer can purchase products in a store or purchase products on an electronic commerce (EC) site. The OMO aims to combine advantages of a physical store and an online store to provide a seamless purchasing experience. For example, a customer can check a product at a store and purchase the product online, or place an order online and pick it up in a store, thereby enabling flexible purchasing methods that meet customer needs.

JP 2023-144956 A discloses a product registration system that aims to improve efficiency of operations related to services provided after settlement at a service counter. In JP 2023-144956 A, a customer can bring a product for which settlement has been completed to a service counter to receive a service of delivering the product to the customer's home or the like. In JP 2023-144956 A, the product displayed in a sales area of a store is delivered.

### SUMMARY

A POS system according to an aspect of the present disclosure includes at least one memory storing instructions; and at least one processor configured to execute the instructions to: register a product for which an operation of reading product information for identifying the product at a store has been performed, receive selection to deliver the product; acquire customer information for identifying a customer who makes a payment and information about a delivery destination of the product, perform in-store accounting processing for the product, and output a request for delivery of the product from electronic commerce inventory based on the customer information and the information about the delivery destination.

A delivery arrangement method according to an aspect of the present disclosure includes registering a product for which an operation of reading product information for identifying the product at a store has been performed, receiving selection to deliver the product, acquiring customer information for identifying a customer who makes a payment and information about a delivery destination of the product, performing in-store accounting processing for the product, and outputting a request for delivery of the product from electronic commerce inventory based on the customer information and the information about the delivery destination.

A non-transitory computer-readable recording medium according to an aspect of the present disclosure stores a program that causes a computer to execute processing of registering a product for which an operation of reading product information for identifying the product at a store has been performed, receiving selection to deliver the product, acquiring customer information for identifying a customer who makes a payment and information about a delivery destination of the product, performing in-store accounting processing for the product, and outputting a request for delivery of the product from electronic commerce inventory based on the customer information and the information about the delivery destination.

As an example of effects according to the present disclosure, it is possible to streamline delivery request operations of the store clerk.

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating an example of connection between a POS system and another device;

FIG. 2 is a block diagram illustrating a configuration example of a POS system;

FIG. 3 is a diagram illustrating an example of a delivery option selection screen;

FIG. 4 is a diagram illustrating an example of a delivery destination selection screen;

FIG. 5 is a flowchart illustrating an operation example of the POS system;

FIG. 6 is a block diagram illustrating a configuration example of a delivery arrangement system;

FIG. 7 is a flowchart illustrating an operation example of an order management server;

FIG. 8 is a block diagram illustrating a configuration example of a POS system;

FIG. 9 is a flowchart illustrating an operation example of the POS system; and

FIG. 10 is a block diagram illustrating an example of a hardware configuration of a computer.

### EXAMPLE EMBODIMENT

### First Example Embodiment

Hereinafter, a delivery arrangement system that enables purchasing of products at a store and the delivery arrangement in a series of continuous flows will be described. This system links a point of sales (POS) system with an order management system of an EC site to allow a customer to make a delivery request when purchasing the product at a store. Accordingly, the customer can check the product at a store and request delivery, thereby eliminating the need to take the product home. A store can streamline processing of the delivery request, thereby achieving an improved customer service and an operational efficiency.

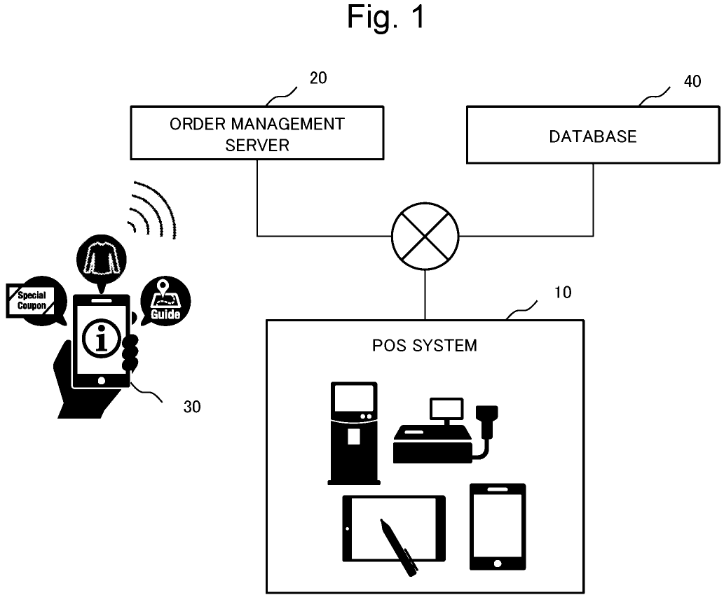

An example of connection between a POS system 10 and another device in the present disclosure will be described with reference to FIG. 1. A delivery arrangement system according to the present disclosure includes the POS system 10 and an order management server 20. The POS system 10 is communicably connected to the order management server 20 and a database 40 via a communication network. The POS system 10 and the order management server 20 are, as needed, communicably connected to a customer terminal 30.

The POS system 10 performs sales management and settlement processing in a store. The POS system 10 includes a POS terminal installed in a store and a POS server. The POS terminal provides an interface operated by a store clerk or a customer in a store, and has functions such as product registration, settlement processing, and reception of the delivery request. The POS terminal may include both a customer display and a store clerk display. This enables both the store clerk and the customer to perform a transaction and a delivery arrangement while checking necessary information. In the POS system 10, a registration machine that performs product registration and a settlement machine that makes settlement processing may be provided separately. The POS server supervises a plurality of POS terminals, and performs functions such as aggregation of sales data, inventory management, and price management. The POS server also performs data linkage with the order management server 20 and the database 40.

The POS system 10 is linked with a store sales database (DB) and a store product master DB. The store sales DB records detailed information of each transaction (a date and time, a product, a quantity, a price, a payment method, and the like). The POS system 10 updates the store sales DB each time a transaction is completed, thereby enabling real-time grasping of a sales status. The store product master DB registers information about all products handled in a store (a product code, a product name, a price, an inventory quantity, and the like). As a product code, for example, a Japanese Article Number (JAN) code is used. At the time of product registration, the POS system 10 refers to the store product master DB to acquire product information and prices. Each time a sale or a receipt occurs, an inventory quantity is updated to maintain the latest inventory status.

The order management server 20 performs EC delivery linkage for a product purchased in a store. Specifically, the order management server 20 processes delivery-request information received from the POS system 10 and links the information to an EC delivery system. It also has a function of making an inquiry about a delivery status in response to a request from the customer terminal 30. The order management server 20 also receives ordinary orders on an electronic commerce site. The order management server 20 manages an EC sales DB, an EC inventory DB, an EC member DB, and an EC product master DB. The EC sales DB manages the order history of electronic commerce. The EC inventory DB manages the inventory status of the electronic commerce product stored in the warehouse and the like. The EC member DB manages member information. The EC product master DB manages detailed information about products. These DBs are managed separately from the database 40, but data linkage and synchronization are performed as needed. The order management server 20 also provides a function that allows a customer to check purchase information when the customer logs in to an EC site.

The database 40 stores customer information. In the database 40, a plurality of delivery destinations can be registered for each customer. The customer registers the address of delivery destinations via the customer terminal 30 or the POS system 10. The delivery destination need not necessarily be the customer's own address, and for example, it is possible to register an address of a friend or family member as a gift. The database 40 can perform unified management of various types of information about a customer, such as a purchase history in a store and a history of use of the EC and can function as an integrated customer platform. The POS system 10 and the order management server 20 access this database as needed to refer to and update customer information and delivery destination information.

A customer terminal 30 is a terminal device used by a customer, such as a smartphone, a tablet, or a personal computer. A customer can access an EC site using the customer terminal 30 to browse the product, place an order, and check the delivery status. Even for the product purchased at a store, by logging in the EC site, it is possible to view details of the purchased product, confirm completion of payment, and track a delivery status. It is possible to subsequently input or change information about a request for delivery of the product purchased at the store. Furthermore, the system may be utilized at the time of in-store shopping and may be used to check product information, perform mobile payments, and use digital coupons. The customer terminal 30 may be used as part of the POS system 10.

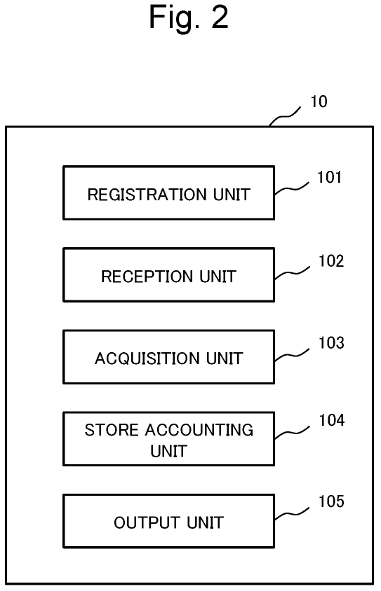

A configuration example of the POS system 10 in the present disclosure will be described with reference to FIG. 2. The POS system 10 mainly includes a registration unit 101, a reception unit 102, an acquisition unit 103, a store accounting unit 104, and an output unit 105. These functional units are implemented, for example, by cooperation between the POS terminal and the POS server. The POS terminal mainly provides a direct interface with a customer, and the POS server is responsible for entire store transaction management and back-end processing, but actual processing of each functional unit is flexibly shared among these components.

The registration unit 101 registers a product for which an operation of reading product information for identifying a store product has been performed. The product information is, for example, a product code that identifies a product. When the product code is given to the product as a barcode, an operation of reading is performed by a barcode reader. When a wireless tag is attached, an operation of reading is performed using a Radio Frequency Identification (RFID) reader. The registration unit 101 acquires, based on a read identification code, information about the product (such as a product name, a price, and an inventory quantity) from a store product master DB. The registration unit 101 displays the acquired product information on a screen of the POS terminal and, as necessary, receives additional operations such as input of a quantity and application of a discount. The registration unit 101 temporarily holds the registered product information in preparation for subsequent processing (such as accounting and a delivery request).

The operation of reading product information may be performed by a store clerk, or may be performed by a customer in a self-checkout method. Various registration methods can be used, such as a method in which a customer scans a product in advance with a smartphone application to transmit the information to the POS system 10.

The reception unit 102 receives selection to deliver a product registered by the registration unit 101. “Receiving the selection” means that a customer or a store clerk specifies whether delivery of the product is desired, and the system recognizes and processes the specification. This selection can be made in various ways, such as operation on a touch screen, input via a keyboard or a mouse, or a voice command. Through these operations, the reception unit 102 receives delivery selection by the customer and displays the selection result on a screen in real time. The reception unit 102 may receive selection to deliver all registered products. In case of selecting whether delivery is performed for each product, the reception unit 102 may cause a store display to display, in a distinguishable manner, a product to be taken home from store inventory and a product for which delivery has been selected. For example, respective lists of the products to be taken home and the products to be delivered are displayed.

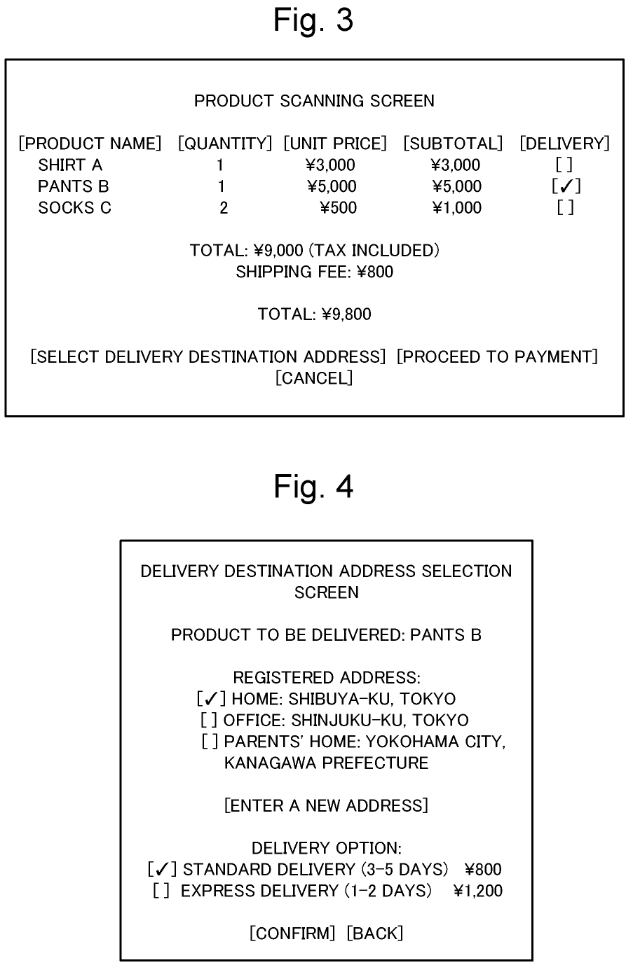

FIG. 3 illustrates an example of a product scanning screen of the POS system 10. Such a screen is displayed on a customer display and a store clerk display. On the customer display, a customer can make selection, and on the store clerk display, a store clerk can make selection on behalf of the customer according to the customer’s requests. On this screen, a list of registered products is displayed, and a delivery selection can be made for each product. On the product scanning screen, respective columns of [product name], [quantity], [unit price], [subtotal], and [delivery] are displayed. A checkbox is provided in the [delivery] column, and by selecting this checkbox, the customer or the store clerk can make a request for delivery of the product. By using such a checkbox, the product to be taken home from store inventory and the product for which delivery has been selected are distinguished and displayed on a store display. When the [proceed to payment] button is pressed, the reception unit 102 finalizes the selected content and advances the process to a next processing stage.

The reception unit 102 can receive selection as to whether a product is for a gift. A product specified as a gift is provided with an additional service, such as special wrapping. With this function, it is possible to send a product purchased at the store directly as a gift, thereby improving customer convenience.

The acquisition unit 103 acquires customer information that identifies a customer who makes a payment, and information about a delivery destination for the product. Operations for acquiring the customer information and the information about the delivery destination may be performed by a store clerk or by a customer. A store clerk can ask a customer for information and input the customer information and the information about the delivery destination. The acquisition unit 103 causes the acquired information to be displayed on a screen in real time.

The customer information is information for managing a person who makes a delivery request. As the customer information, for example, a membership number that uniquely identifies a customer is used. A customer’s name and contact information are linked to the membership number. Personal information such as the customer’s name and contact information is linked to the membership number, which is used for delivery and inquiries. The acquisition unit 103 acquires member information by reading, for example, a member card possessed by the customer or a code displayed on a smartphone. Even when the customer is not a member, it is possible to have the customer input minimum necessary information (such as name and contact information) on the spot and acquire the information as temporary customer information.

The information about the delivery destination is information for identifying a delivery destination that identifies a place to which a product is delivered. In the first example embodiment, the information about the delivery destination includes a specific delivery destination address. The acquisition unit 103 may acquire address information that has been registered in advance in a database 40 linked to the customer information. The acquisition unit 103 may acquire address information input through a store POS terminal. To facilitate input of address information, a tablet-type terminal may be used. A customer or a store clerk can directly input an address on a tablet screen using a touch pen or can select the address from a prepared address list.

For example, when the [select delivery destination] button in FIG. 3 is pressed, a delivery destination selection screen as illustrated in FIG. 4 is displayed. On the delivery destination selection screen of FIG. 4, a product name to be delivered can be displayed, and selection can be made from a list of registered addresses. An option to input a new address is provided. Furthermore, as delivery options, it is possible to select standard delivery and express delivery, thereby allowing flexible delivery settings according to customer needs. The acquisition unit 103 acquires address information about a selected or input address.

The store accounting unit 104 performs in-store accounting processing for the product registered by the registration unit 101. Performing accounting processing refers to a series of processes up to completion of payment for the registered product. Specifically, the processes include calculation of a total amount for the registered product, processing of applicable discounts and coupons, calculation of taxes, selection and processing of payment methods (such as cash, credit card, and electronic money), and issuance of a receipt.

The store accounting unit 104 may have a function of performing accounting processing for a shipping fee. The store accounting unit 104 calculates a total payment amount including the shipping fee, for example, and displays the total payment amount on a store display. The store accounting unit 104 calculates the shipping fee according to a size and a weight of a product, a region of a delivery destination, and a delivery speed. For a large or heavy product, an additional shipping fee may be incurred. For delivery to certain regions such as remote areas and isolated islands, an additional fee may be required. When special services such as express delivery or delivery at a specified time are selected, an additional fee is incurred. In addition, when a purchase amount exceeds a certain amount, the shipping fee may be free. For example, when there is a campaign such as “shipping fee is zero for purchase of 10,000 yen or more” the store accounting unit 104 checks a total amount of the product to be taken home by the customer and the product to be delivered, and when a condition is satisfied, calculates the shipping fee as zero yen. When a plurality of products is delivered to different addresses, it is possible to individually calculate a shipping fee according to each delivery destination.

The output unit 105 outputs a request for delivery of the registered product from electronic commerce inventory, based on the customer information and the information about the delivery destination. The output unit 105 mainly transmits this delivery request to the order management server 20. The order management server 20 performs an actual delivery arrangement based on this information. The delivery request herein refers to an electronic instruction sheet that summarizes information necessary for delivery of a product. The delivery request includes, for example, the following information: customer information (such as a name and contact information), delivery destination address, details of the product to be delivered (such as a product name, a quantity, and a size), delivery options (such as standard delivery and express delivery), payment information (such as whether payment has been made or cash on delivery), and information about at which store the accounting processing was performed (such as a store code and a store name).

The physical products in the store are held as store inventory. Among the products registered by the registration unit 101, only the product that the customer takes home on the spot is subtracted from the store inventory quantity. On the other hand, for the product for which delivery is selected, the store inventory quantity is not changed, and the product is delivered from electronic commerce inventory.

The output unit 105 may have a function of printing a reception confirmation slip of a delivery request as a copy for a customer. This confirmation slip is printed, for example, by a receipt printer. The output unit 105 may have a function of printing a tag to be attached to a product scheduled to be delivered from EC inventory. On this tag, indications such as “EC delivery product” “return required product” and “store retained product” are printed, and a store clerk can check the tag and return the product to a display shelf or a back room.

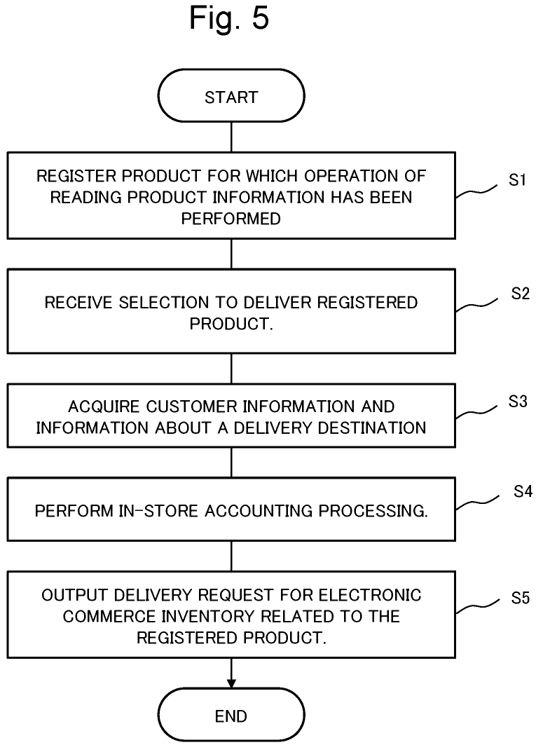

An operation example of the POS system 10 in the present disclosure will be described with reference to FIG. 5. The POS system 10 starts the process of FIG. 5, for example, in response to having received product information from a terminal by which an operation of reading product information has been performed.

In step S1, the registration unit 101 registers a product for which an operation of reading product information for identifying a store product has been performed. In step S2, the reception unit 102 receives selection to deliver the product registered by the registration unit 101. In step S3, the acquisition unit 103 acquires customer information for identifying a customer who makes a payment and information about a delivery destination of a product.

The order of steps S1, S2, and S3 is not limited to this. For example, the customer information in step S3 may be acquired first, followed by the product registration in step S1. The selection to deliver the product to be registered in step S2 may be received first, and thereafter, in step S1, the product may be registered.

In step S4, the store accounting unit 104 performs in-store accounting processing for the product registered by the registration unit 101. The output unit 105 outputs a request for delivery of the registered product from electronic commerce inventory, based on the customer information and the information about the delivery destination. The output unit 105 mainly transmits this delivery request to the order management server 20. Thus, the POS system 10 ends the process of FIG. 5.

According to the first example embodiment, it is possible to streamline delivery request operations of the store clerk. The reason is that the output unit 105 automatically outputs the request for delivery of the registered products from electronic commerce inventory based on the customer information and the information about the delivery destination. Since only a scanning operation by a store clerk causes product information to be automatically reflected in the delivery request by means of the registration unit 101 and the reception unit 102, the store clerk need not input product information separately. Thus, in addition to ordinary accounting processing, a store clerk can complete the delivery arrangement merely by selecting delivery or by prompting a customer to select delivery. As a result, a store clerk no longer is required to create a delivery request manually, and the working time can be reduced.

Generally, purchasing the product at a store and using a delivery service are separate procedures. Such procedures impose a burden, including creation of delivery slips and input of customer information, on a store clerk. One object of the present disclosure is to provide a POS system that streamlines delivery request operations of the store clerk.

According to the first example embodiment, the output unit 105 cooperates with a delivery function of an electronic commerce system by transmitting the delivery request to the order management server 20. This makes it possible to integrate inventory management and delivery processing between a store and electronic commerce and to enable an efficient operation. A store clerk does not need to pack store inventory and prepare it for shipment. The consistent service can be provided to the customer through an omnichannel approach.

Furthermore, according to the first example embodiment, the delivery arrangement can be made in the same flow as the in-store accounting processing, which is convenient for a customer. The reason is that the POS system 10 performs a series of processes of product registration, delivery selection, acquisition of customer information, accounting processing, and output of a delivery request. Accordingly, a customer can complete a delivery arrangement simultaneously with product purchase without any additional procedures. Since the acquisition unit 103 can acquire a pre-registered delivery destination address from the customer information, in many cases no new address entry is required. Thus, a customer’s effort can be reduced.

### Second Example Embodiment

A delivery arrangement system according to the second example embodiment has a function that allows a delivery destination address to be entered after purchase at a store. Since a basic configuration of the delivery arrangement system according to the second example embodiment is the same as that of the first example embodiment, differences will be mainly described. As a case in which a delivery destination address is entered later, it is assumed that a customer does not enter the delivery destination address at the time of purchase at the store. Only part of the delivery destination address may be entered at the store. Or, the delivery destination address entered at the store may be changed later.

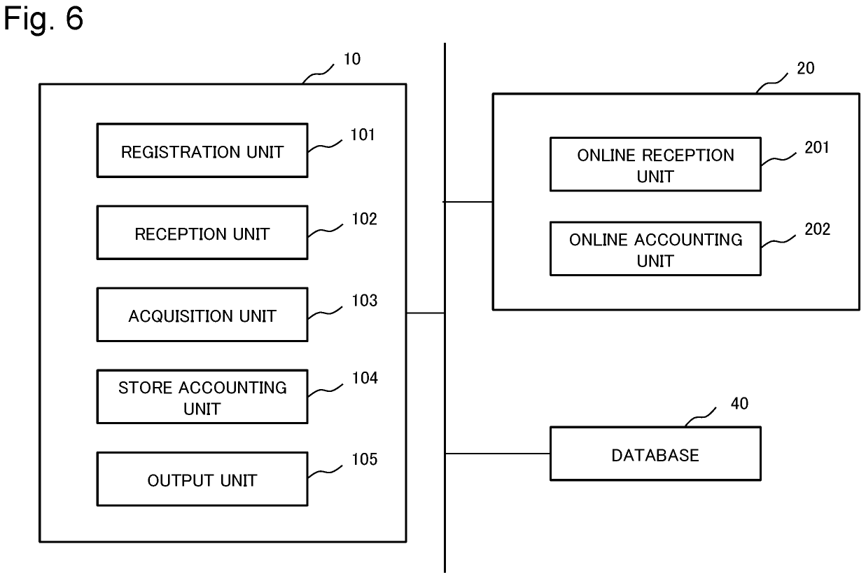

A configuration example of the delivery arrangement system according to the present disclosure will be described with reference to FIG. 6. As in the first example embodiment, the delivery arrangement system includes the POS system 10 and the order management server 20. In the second example embodiment, the order management server 20 includes an online reception unit 201 and an online accounting unit 202.

First, a case will be assumed in which the delivery destination address is not entered at the store. The POS system 10 can output a delivery request even when the delivery destination address is not yet entered. For example, in the screen of FIG. 3, when the “proceed to payment” button is pressed without pressing “select delivery destination”, the acquisition unit 103 displays a warning such as “no delivery destination is selected”. However, when a customer wishes to enter the delivery destination at a later date, the acquisition unit 103 acquires, as the information about the delivery destination, information indicating that the delivery destination address is not yet determined. The acquisition unit 103 acquires customer information for identifying the customer (for example, a membership number, a name, a telephone number, and the like). This customer information is used to identify the customer when the delivery destination address is entered at a later date. Thereafter, when accounting processing by the store accounting unit 104 is performed, the output unit 105 outputs, to the order management server 20, a delivery request indicating that the delivery destination address is not yet determined.

As the customer information for identifying a customer who makes a payment, a provisional customer number or a character string for identifying the accounting may be used. For example, when information sufficient to identify the customer is not entered by the customer at the store, a number assigned by the POS system 10 or an accounting identifier is used as the customer information. With a configuration in which the acquisition unit 103 acquires such customer information, even a non-membership customer can transmit a delivery request. A customer can, at the time of address entry, enter a name, a contact information, and the like.

An online reception unit 201 of the order management server 20 generates a link or a notification to allow address entry later using the customer terminal 30. The online reception unit 201 generates, for example, a link based on the customer information acquired by the acquisition unit 103. This link is, for example, printed as a two-dimensional code (QR code) on a receipt via the POS system 10 in such a way that a customer can easily access an address entry page by reading the link with a smartphone or the like. It is conceivable that the online reception unit 201 transmits the link to a customer’s registered e-mail address or transmits a notification to a mobile application of the store used by the customer. The above link may be generated by the POS system 10.

The online reception unit 201 receives entry of a delivery destination address from the customer terminal 30 based on the delivery request output from the output unit 105 of the POS system 10. Specifically, using the customer information and the product information included in the delivery request, the order is identified, and entry of the delivery destination address for the order is received. For example, when a customer accesses the system by reading the two-dimensional code, information related to the order (a purchase date and time, a product name, a price, and the like) is displayed in such a way that the customer can check the correct order. When the customer is a member, the online reception unit 201 displays a screen for entering the delivery destination address, for example, on a screen after the customer logs in from the customer terminal 30 to a personal page of the EC site. On this screen, a pre-registered delivery destination address may be displayed as selectable. When the customer is a non-member, the online reception unit 201 may receive additional entry of information (a name, an address, contact information, and the like) more detailed than the customer information acquired at the store. For example, when a name is entered in katakana at the store, the online reception unit 201 receives entry of the name in kanji. A customer can perform membership registration at the time of entering the delivery destination address.

The online reception unit 201 receives address information input from the customer terminal 30 and completes a delivery arrangement. The online reception unit 201 can set a deadline for entering the delivery destination address and define a default operation, such as delivering the product to a customer’s registered address if no entry is made by the deadline.

According to the online reception unit 201, a customer can enter an address in a peaceful environment, thereby reducing input errors. A customer forwards a dedicated link to a person at the delivery destination to request entry of the delivery destination address. With this function, a delivery destination can be decided after purchase at a store, which is suitable for uses such as gifts. In addition, in the case of a gift, the online reception unit 201 can enhance customer convenience by allowing later entry of content of a message card or the like.

An online accounting unit 202 performs accounting processing for a shipping fee. For example, this function is used when accounting processing for a shipping fee is not performed at the store. It is assumed that accounting processing for a shipping fee is not performed for the reason that the delivery destination address is not yet determined and thus the store cannot calculate an exact shipping fee. The online accounting unit 202 calculates an exact shipping fee based on the delivery destination address entered by the customer at a later date and processes additional payment as necessary. The online accounting unit 202 can perform accounting processing for a difference between an estimated shipping fee processed at the store for the product and an actual shipping fee. For example, only a minimum shipping fee is paid at the store, and when an additional fee is required for delivery to a remote area or the like, the online accounting unit 202 processes payment of the difference. When the actual shipping fee is higher than the estimate, the customer is requested to make additional payment. In this case, a customer’s registered credit card is charged, or another payment method is proposed. When the actual shipping fee is lower than the estimate, the difference is refunded to the customer. The refund is processed by transfer to a customer’s registered account or as a credit toward a next purchase.

Next, a case will be assumed in which the regional attribute of the delivery destination is entered at the store. The regional attribute refers to, for example, information of a prefecture or municipality level. As the regional attribute, it is possible to enter whether the delivery destination is a remote area or an isolated island. This function is useful when a customer does not know an exact address or does not want to enter a detailed address at the store from a privacy standpoint. The acquisition unit 103 acquires the regional attribute as the information about the delivery destination. A case in which only the regional attribute is entered corresponds to a case in which the information about the delivery destination does not include a delivery destination address. Even when the acquired information about the delivery destination does not include the delivery destination address, the store accounting unit 104 can calculate a shipping fee and perform accounting processing based on the regional attribute. A customer completes a delivery arrangement by entering an exact address at a later date via the online reception unit 201.

Furthermore, a case will be assumed in which an address is entered at the store but is changeable later. For example, a customer can once enter a home address and later change it to a recipient’s address for a gift destination. It is possible to change delivery of a plurality of products purchased at the store to different delivery destinations. The online reception unit 201 sets a deadline for a change in the delivery destination and receives the change from the customer terminal 30 within the deadline. This function allows a customer to flexibly change a delivery destination after purchase.

An online accounting unit 202 recalculates a shipping fee based on a changed address. For example, when the delivery destination is changed to a location farther than an original delivery destination, an additional shipping fee may be incurred. In this case, the online accounting unit 202 processes payment of a difference. Conversely, when the delivery destination is changed to a nearer location, the online accounting unit 202 performs refund processing for an overpayment. Accordingly, adjustments to the shipping fee in association with a change in the delivery destination can be properly carried out.

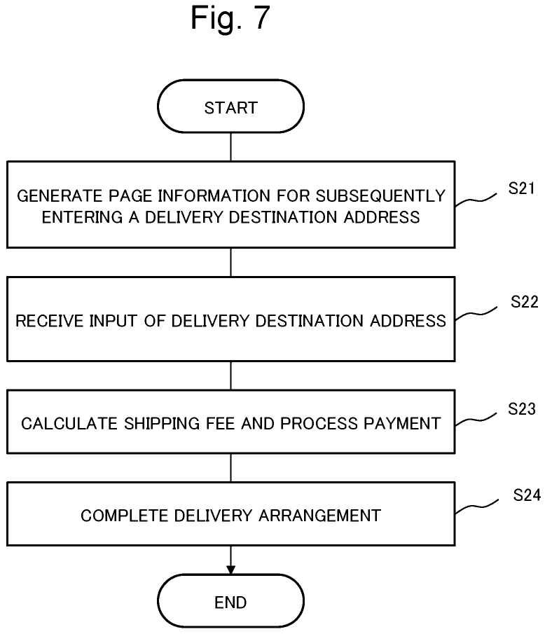

With reference to FIGS. 5 and 7, an operation example of a delivery arrangement system according to the present disclosure will be described. The following operation example assumes a case where a delivery destination is not entered at the time of purchase at a store.

First, a POS system 10 starts a process of FIG. 5 in response to receiving product information from a terminal by which an operation of reading product information has been performed. In step S1, the registration unit 101 of the POS system 10 registers the product for which an operation of reading product information for identifying the product at a store has been performed. In step S2, the reception unit 102 receives selection to deliver the registered product. In step S3, the acquisition unit 103 acquires customer information for identifying a customer who makes a payment. As information about a delivery destination, the acquisition unit 103 acquires information indicating that a delivery destination address is not yet determined.

In step S4, the store accounting unit 104 performs in-store accounting processing for the registered product. In step S5, the output unit 105 outputs, to the order management server 20, a delivery request indicating the customer information and that the delivery destination address is not yet determined.

The order management server 20 starts a process of FIG. 7 in response to, for example, receiving the delivery request output in step S5.

In step S21, the online reception unit 201 of the order management server 20 generates page information for later address entry. For example, the online reception unit 201 generates a link to a page or a notification and provides it to a customer by means of email, an app notification, receipt printing, or the like. In step S22, the online reception unit 201 receives input of a delivery destination address from the customer terminal 30.

In step S23, the online accounting unit 202 calculates a shipping fee based on the input delivery destination address and processes an additional payment as necessary. The step is optional and is executed when an accurate shipping fee could not be calculated at the store or when a difference in the shipping fee arises due to a change in the delivery destination.

In step S24, the order management server 20 completes a delivery arrangement based on the input delivery destination address. Specifically, the order management server 20 transmits delivery request data to a carrier’s system and finalizes a delivery schedule. The order management server 20 issues a shipping instruction for the product and updates an inventory management system as necessary. Further, the order management server 20 notifies the customer of information such as an expected delivery date and a tracking number. Thus, a series of processes from in-store purchase to delivery are completed.

According to the second example embodiment, the acquisition unit 103 acquires information indicating that a delivery destination address is not yet determined, and the output unit 105 outputs, to the order management server 20, a delivery request indicating that the delivery destination address is not yet determined. The online reception unit 201 of the order management server 20 generates a link or a notification to enable address entry later by the customer terminal 30 and provides it to a customer. Accordingly, customer convenience is improved. For example, even when the customer is in a hurry or does not know an accurate address, the customer can purchase the product and make a delivery request. Since the customer can accurately enter the address in a peaceful environment, input errors can be reduced. The system is useful from a privacy standpoint when the customer does not want to enter a detailed address at a store. Since a delivery destination can be determined after purchase, for example, upon purchasing a gift, flexible handling is enabled. The customer can request a person at the delivery destination to enter the address directly, and obtain more accurate address information.

In addition, since the online accounting unit 202 can calculate an accurate shipping fee after entry of the delivery destination address and process an additional payment or a refund, fair and highly transparent pricing can be achieved.

### Third Example Embodiment

A delivery arrangement system according to the third example embodiment has a function of determining inventory to be delivered based on the inventory quantity of electronic commerce (EC) inventory and the inventory quantity of store inventory. Since a basic configuration of the delivery arrangement system according to the third example embodiment is similar to that of the first example embodiment, mainly differences will be described.

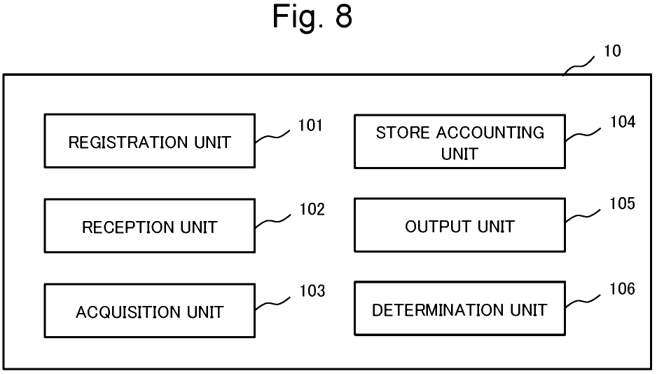

A configuration example of the delivery arrangement system according to the present disclosure will be described with reference to FIG. 8. In the third example embodiment, the POS system 10 includes, in addition to the configuration of the first example embodiment, a determination unit 106.

A determination unit 106 determines whether to deliver electronic commerce inventory or store inventory. For example, the determination unit 106 determines which inventory to deliver based on the inventory quantity of the electronic commerce inventory and the inventory quantity of the store inventory. Alternatively, the determination unit 106 may determine which inventory to deliver based on a positional relationship between a location of the inventory and the delivery destination address.

When delivering a product from store inventory, there is a method of delivering the product directly from a store to a delivery destination. For example, a carrier comes to the store to pick up the product. Store staff performs packing of the product and hands it over to the carrier. The carrier then delivers the product to the delivery destination as is. There is a method of delivering the product via an EC warehouse from a store. In this method, the store product is first sent to the EC warehouse. After receipt at the EC warehouse, the product is packed in the same manner as another EC inventory and shipped to the delivery destination. This method allows centralized packing and delivery processing at the EC warehouse and is suitable when efficiently processing a large number of orders. It also has an advantage of reducing a packing workload of store staff.

Depending on store operations, as a general rule, electronic commerce (EC) inventory is prioritized for delivery. When the EC inventory is sufficient, delivery is made from the EC inventory. However, when the EC inventory is low or there is no EC inventory, the store inventory is delivered. In addition, the determination unit 106 can make a determination in consideration of the positional relationship between the location of the inventory and the delivery destination address. For example, it may be determined to deliver the product from the inventory location (an EC warehouse or a store) closest to the delivery destination address. This enables shortening of delivery time and reduction of cost.

As the store inventory, the determination unit 106 can determine to deliver inventory of another store. When another store has a large inventory quantity or another store is close to the delivery destination, delivery of inventory of the another store is determined. In this case, the inventory of the another store is delivered to the delivery destination. Alternatively, the store inventory is collected to the EC warehouse and then delivered.

The output unit 105 outputs a delivery request based on a determination of the determination unit 106. The delivery request includes information about a delivery origin (a store or an electronic commerce warehouse). When delivering the EC inventory, the output unit 105 outputs the delivery request to the order management server 20. When delivering the store inventory, the output unit 105 outputs, for example, a delivery request to an in-store delivery management system. When delivering the store inventory via the EC warehouse, the output unit 105 outputs, to an in-store inventory transfer system, an instruction for inventory transfer to the EC warehouse to output a delivery request to the order management server 20.

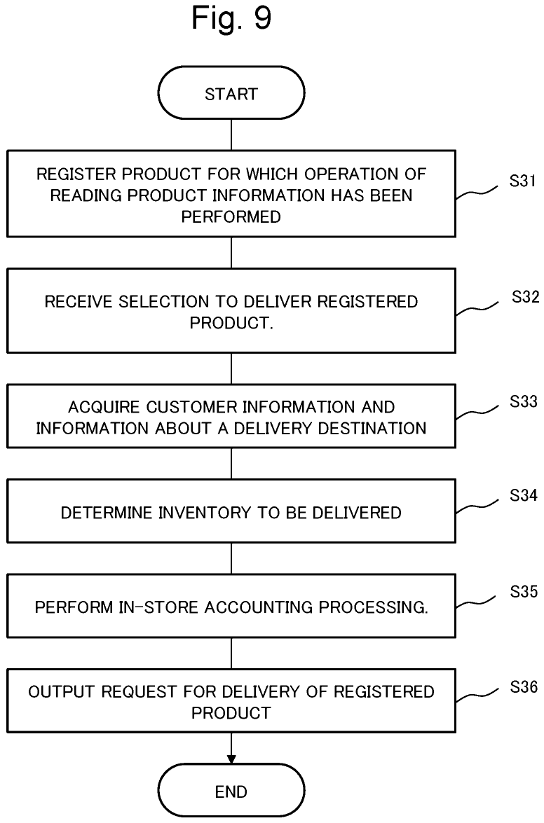

With reference to FIG. 9, an operation example of the delivery arrangement system according to the present disclosure will be described. This operation example assumes a case where delivery is selected at the time of in-store purchase.

In step S31, the registration unit 101 of the POS system 10 registers a product for which an operation of reading product information for identifying the product at a store has been performed. In step S32, the reception unit 102 receives selection to deliver the registered product. In step S33, an acquisition unit 103 acquires customer information for identifying a customer who makes a payment and information about a delivery destination of the product.

In step S34, the determination unit 106 determines inventory to be delivered based on the inventory quantity of the electronic commerce inventory and the inventory quantity of the store inventory. In step S35, the store accounting unit 104 performs in-store accounting processing for the registered product. Step S34 may be performed after step S35. In step S36, the output unit 105 outputs a request for delivery of the registered product. Specifically, for example, the output unit 105 outputs, to the order management server 20, a delivery request including the customer information, the information about the delivery destination, and the information about the determined delivery origin.

According to the third example embodiment, the determination unit 106 determines the inventory to be delivered, and the output unit 105 outputs a delivery request based on the determination. Accordingly, efficiency in inventory management and delivery can be achieved. For example, by preferentially using EC inventory, it is possible to secure store inventory for sales at a physical store while efficiently conducting sales in an omnichannel manner. By shipping a product from a location close to a delivery destination, it is possible to shorten delivery time and reduce costs.

Furthermore, by flexibly using EC inventory and store inventory, the risk of stockouts can be reduced, leading to improved customer satisfaction. In addition, by reallocating inventory between warehouses or stores, overall inventory efficiency can be increased.

### Hardware Configuration

In each example embodiment described above, each component of the POS system 10 and the order management server 20 indicates a block of functional units. Some or all of the components of the POS system 10 and the order management server 20 may be achieved by any combination of the computer 500 and a program.

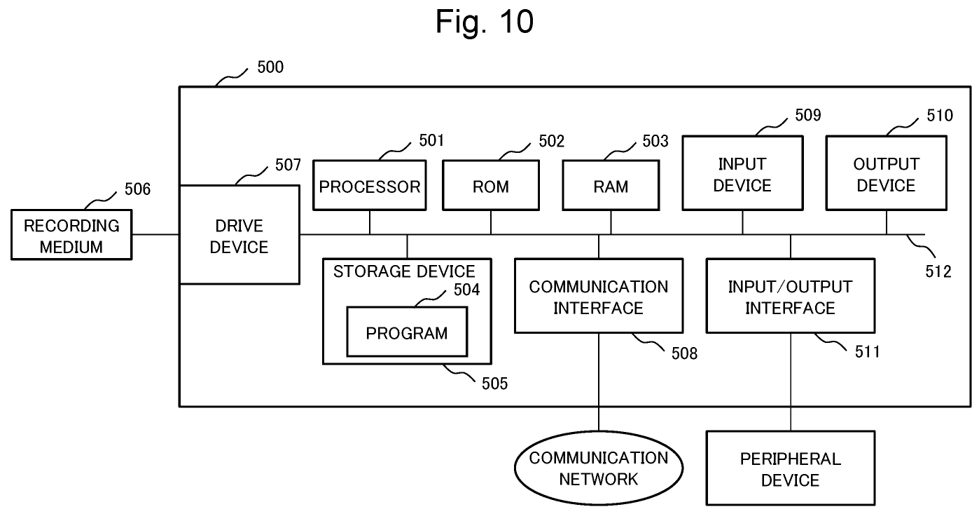

FIG. 10 is a block diagram illustrating an example of a hardware configuration of a computer 500. Referring to FIG. 10, the computer 500 includes, for example, a processor 501, a read only memory (ROM) 502, a random access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes instructions for implementing respective functions of the POS system 10 and the order management server 20. The program 504 is stored in advance in the ROM 502, the RAM 503, and the storage device 505. The processor 501 implements the functions of the POS system 10 and the order management server 20 by executing instructions included in the program 504. The RAM 503 may store data processed in the respective functions of the POS system 10 and the order management server 20.

The drive device 507 reads and writes a recording medium 506. The communication interface 508 provides an interface with a communication network. The input device 509 is, for example, a mouse, a keyboard, or the like, and receives an input of information from an administrator or the like. In addition, dedicated input devices such as a barcode reader and a tag reader are connected to the POS system 10. The output device 510 is, for example, a display, and outputs (displays) information to the administrator or the like. Dedicated output devices such as a customer-facing display and a receipt printer are connected to the POS system 10. The input/output interface 511 provides an interface with a peripheral device. The bus 512 connects the components of the hardware. The program 504 may be supplied to the processor 501 via the communication network or may be stored in advance in the recording medium 506, and the drive device 507 may read the program and supply the program to the processor 501.

The hardware configuration illustrated in FIG. 10 is an example, and other components may be added or some components may not be included.

There are various modifications regarding methods of implementing the POS system 10 and the order management server 20. For example, the POS system 10 and the order management server 20 may be achieved by any combination of a computer and a program different for each component. A plurality of components included in the POS system 10 and the order management server 20 may be achieved by any combination of one computer and a program.

At least part of the POS system 10 may be provided in a software as a service (SaaS) format. That is, at least some of the functions for implementing the POS system 10 may be executed by software executed via the network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

A POS system including

a registration means for registering a product for which an operation of reading product information for identifying the product at a store has been performed,

a reception means for receiving selection to deliver the product,

an acquisition means for acquiring customer information for identifying a customer who makes a payment and information about a delivery destination of the product,

a store accounting means for performing in-store accounting processing for the product, and

an output means for outputting a request for delivery of the product from electronic commerce inventory based on the customer information and the information about the delivery destination.

### Supplementary Note 2

The POS system according to Supplementary Note 1, wherein

when the acquired information about the delivery destination does not include a delivery destination address, the output means outputs the delivery request indicating that a delivery destination address is not yet determined.

### Supplementary Note 3

The POS system according to Supplementary Note 1 or 2, wherein

the reception means causes a store display to display, in a distinguishable manner, a product that is to be taken home from store inventory and a product for which delivery has been selected among the registered products.

### Supplementary Note 4

The POS system according to any one of Supplementary Notes 1 to 3, wherein

even when the acquired information about the delivery destination does not include a delivery destination address, the store accounting means performs accounting processing for a shipping fee based on a regional attribute of the delivery destination indicated by the acquired information about the delivery destination.

### Supplementary Note 5

The POS system according to any one of Supplementary Notes 1 to 4, further including

a determination means for determining whether to deliver electronic commerce inventory or store inventory, based on an inventory quantity of electronic commerce inventory and an inventory quantity of store inventory, or based on a positional relationship between a location of inventory and a delivery destination address, wherein

the output means outputs a request for delivery of the product from inventory based on the determination.

### Supplementary Note 6

The POS system according to any one of Supplementary Notes 1 to 5, wherein

the output means outputs the delivery request to an order management server that receives an order on an electronic commerce site and arranges delivery of an ordered product from electronic commerce inventory.

### Supplementary Note 7

A delivery arrangement system including

the POS system according to any one of Supplementary Notes 1 to 6, and

an order management server including an online reception means for receiving input of a delivery destination from a customer terminal associated with the customer information with respect to the product for which the delivery request has been output.

### Supplementary Note 8

The delivery arrangement system according to Supplementary Note 7, wherein

the order management server further includes an online accounting means for performing accounting processing for a difference between a shipping fee processed at a store for the product and an actual shipping fee.

### Supplementary Note 9

A delivery arrangement method including

registering a product for which an operation of reading product information for identifying the product at a store has been performed,

receiving selection to deliver the product,

acquiring customer information for identifying a customer who makes a payment and information about a delivery destination of the product,

performing in-store accounting processing for the product, and

outputting a request for delivery of the product from electronic commerce inventory based on the customer information and the information about the delivery destination.

### Supplementary Note 10

A program for causing a computer to execute the steps of

registering a product for which an operation of reading product information for identifying the product at a store has been performed,

receiving selection to deliver the product,

acquiring customer information for identifying a customer who makes a payment and information about a delivery destination of the product,

performing in-store accounting processing for the product, and

outputting a request for delivery of the product from electronic commerce inventory based on the customer information and the information about the delivery destination.

Some or all of the configurations described in Supplementary Notes 2 to 8 dependent on the above-described Supplementary Note 1 can be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, and 9 and 10, but also various pieces of hardware and software, and various recording devices or systems for recording software without departing from the above-described example embodiments.

1. A POS system comprising:
at least one memory storing instructions; and
at least one processor configured to execute the instructions to:
register a product for which an operation of reading product information for identifying the product at a store has been performed;
receive selection to deliver the product;
acquire customer information for identifying a customer who makes a payment and information about a delivery destination of the product;
perform in-store accounting processing for the product; and
output a delivery request for delivery of the product from electronic commerce inventory based on the customer information and the information about the delivery destination.

2. The POS system according to claim 1, wherein the at least one processor is further configured to execute the instructions to:
in a case where the acquired information about the delivery destination does not include the delivery destination address, output the delivery request indicating that a delivery destination address is not yet determined.

3. The POS system according to claim 1, wherein the at least one processor is further configured to execute the instructions to:
cause a store display to display, in a distinguishable manner, a product that is to be taken home from store inventory and a product for which delivery has been selected among the registered products.

4. The POS system according to claim 1, wherein the at least one processor is further configured to execute the instructions to:
even in a case where the acquired information about the delivery destination does not include a delivery destination address, perform accounting processing for a shipping fee based on a regional attribute of the delivery destination indicated by the acquired information about the delivery destination.

5. The POS system according to claim 1, wherein the at least one processor is further configured to execute the instructions to:
determine whether to deliver electronic commerce inventory or store inventory, based on an inventory quantity of electronic commerce inventory and an inventory quantity of store inventory, or based on a positional relationship between a location of inventory and a delivery destination address; and
output the delivery request for delivery of the product from inventory based on the determination.

6. The POS system according to claim 1, wherein the at least one processor is further configured to execute the instructions to:
output the delivery request to an order management server that receives an order on an electronic commerce site and arranges delivery of an ordered product from electronic commerce inventory.

7. A delivery arrangement system comprising:
the POS system according to claim 1; and
an order management server including:
at least one memory storing instructions; and
at least one processor configured to execute the instructions to:
receive input of a delivery destination from a customer terminal associated with the customer information with respect to the product for which the delivery request has been output.

8. The delivery arrangement system according to claim 7, wherein the at least one processor of the order management server is further configured to execute the instructions to:
perform accounting processing for a difference between a shipping fee processed at a store for the product and an actual shipping fee.

9. A delivery arrangement method comprising:
registering a product for which an operation of reading product information for identifying the product at a store has been performed;
receiving selection to deliver the product;
acquiring customer information for identifying a customer who makes a payment and information about a delivery destination of the product;
performing in-store accounting processing for the product; and
outputting a delivery request for delivery of the product from electronic commerce inventory based on the customer information and the information about the delivery destination.

10. A non-transitory computer-readable recording medium storing a program for causing a computer to execute processing of:
registering a product for which an operation of reading product information for identifying the product at a store has been performed;
receiving selection to deliver the product;
acquiring customer information for identifying a customer who makes a payment and information about a delivery destination of the product;
performing in-store accounting processing for the product; and
outputting a delivery request for delivery of the product from electronic commerce inventory based on the customer information and the information about the delivery destination.

11. The POS system according to claim 3, wherein
receiving selection to deliver the product includes receiving selection via a checkbox displayed for each registered product on the store display.
